(19) United States
(12) Patent Application Publication
(10) Pub. No.: US 2026/0067281 A1
(43) Pub. Date: Mar. 5, 2026

(54) ACCESS CONTROL LABELING VIA LLM SEMANTIC UNDERSTANDING

(71) Applicant: Cisco Technology, Inc., San Jose, CA (US)

(72) Inventors: Charles Fleming, Oxford, MS (US); Jayanth Srinivasa, Newark, CA (US); Gaowen Liu, Naperville, IL (US); Ramana Rao V.R. Kompella, Foster City, CA (US)

(73) Assignee: Cisco Technology, Inc., San Jose, CA (US)

(21) Appl. No.: 18/821,129

(22) Filed: Aug. 30, 2024

(51) Int. Cl. H04L 9/40; G06F 21/62

(52) U.S. Cl. CPC H04L 63/101; G06F 21/6209

(57) ABSTRACT

In one implementation, a device extracts, using an embedding model, one or more ideas from a particular document. The device determines a measure of similarity between the one or more ideas from the particular document and those of each of a body of existing documents, to identify a set of one or more similar documents. The device generates an access control list for the particular document, based on one or more access control lists associated with the set of one or more similar documents. The device restricts access to the particular document according to the access control list for the particular document.

### TECHNICAL FIELD

The present disclosure relates generally to computer systems, and, more particularly, to access control labeling via Large Language Model (LLM) semantic understanding.

### BACKGROUND

Users in modern enterprises often create new content in the form of files such as spreadsheets, word processing documents, media files, and the like. These files are also often shared across users via document management systems, shared network folders, cloud storage locations, etc. For instance, one user may check in a version of a file to a shared repository, another may later open it to edit its contents, and then check it back into the repository. In other cases, a user may make copies of the file and share them internally and/or externally (e.g., via email, etc.).

Implementing access control to the various files in the network of an enterprise is frequently required by laws, regulations, best practices, company policies, and the like. For instance, files that include sensitive or confidential information such as sales figures, customer lists, or payroll information, may require security protections to prevent unauthorized access.

Ideally, access control would be set on any given file to permit only relevant users to access it. However, accurately setting access controls can make documents hard to share and is often done incorrectly by non-technical personnel, leading to data loss. Current systems that seek to set access controls automatically can also exhibit poor performance because a single user may create documents targeted towards different audiences, depending on the content of the document.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3C illustrate examples of enforcing access controls to documents;

FIG. 4 illustrates an example architecture for access control labeling via Large Language Model (LLM) semantic understanding; and

FIG. 5 illustrates an example simplified procedure for performing access control labeling via LLM semantic understanding.

### DESCRIPTION OF EXAMPLE EMBODIMENTS

### Overview

According to one or more implementations of the disclosure, a device extracts, using an embedding model, one or more ideas from a particular document. The device determines a measure of similarity between the one or more ideas from the particular document and those of each of a body of existing documents, to identify a set of one or more similar documents. The device generates an access control list for the particular document, based on one or more access control lists associated with the set of one or more similar documents. The device restricts access to the particular document according to the access control list for the particular document.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

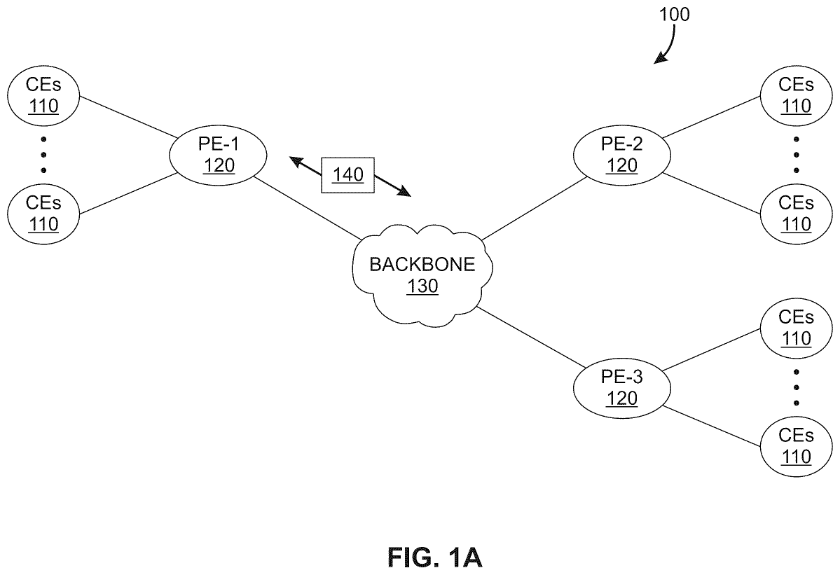

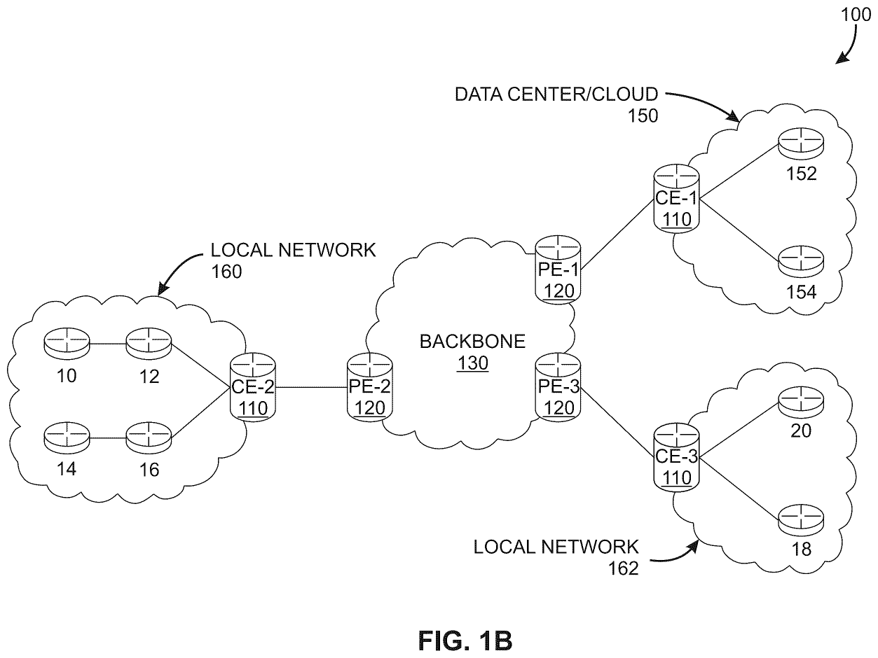

FIG. 1A is a schematic block diagram of an example computer network (e.g., network 100) illustratively comprising nodes/devices, such as a plurality of routers/devices interconnected by links or networks, as shown. For example, customer edge (CE) routers (e.g., CE routers 110) may be interconnected with provider edge (PE) routers 120 (e.g., PE-1, PE-2, and PE-3) in order to communicate across a core network, such as an illustrative network backbone (e.g., network backbone 130). For example, routers (e.g., CE routers 110), routers 120 may be interconnected by the public Internet, a multiprotocol label switching (MPLS) virtual private network (VPN), or the like. Data packets 140 (e.g., traffic/messages) may be exchanged among the nodes/devices of the network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router (e.g., CE routers 110) shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router (e.g., CE routers 110) connected to PE-2 and a second CE router (e.g., CE routers 110) connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks (e.g., network 160-162) that include devices/nodes 10-16 and devices/nodes 18-20, respectively, as well as a data center/cloud environment 150 that includes servers 152-154. Notably, local networks (e.g., network 160-162) and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

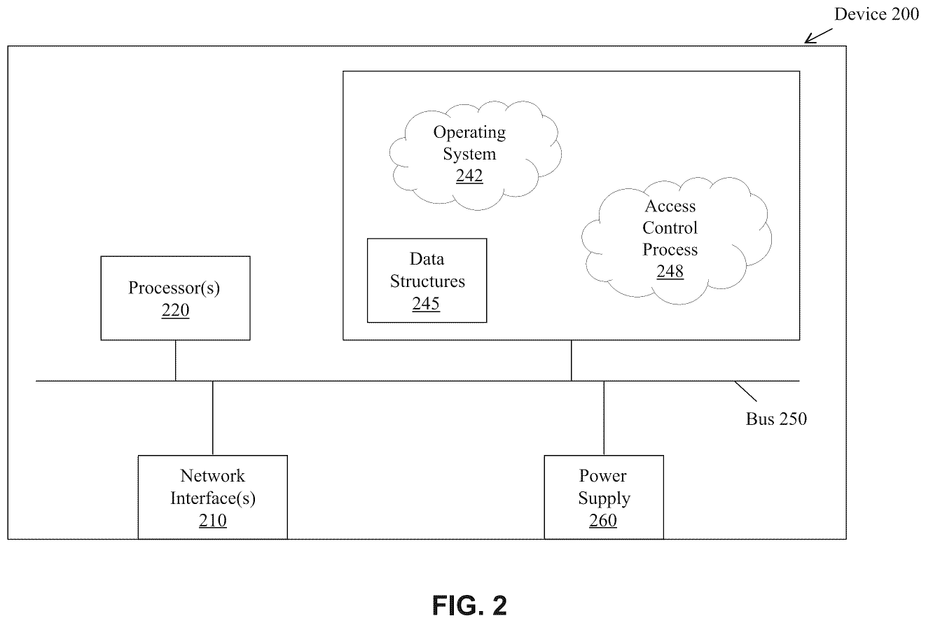

FIG. 2 is a schematic block diagram of an example node/device 200 (e.g., an apparatus) that may be used with one or more implementations described herein, e.g., as any of the computing devices shown in FIGS. 1A-1B, particularly the PE routers (e.g., routers 120), CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces (e.g., network interfaces 210), one or more processors (e.g., processor(s) 220), and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor (e.g., processor(s) 220) may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a access control process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, access control process 248 may include computer executable instructions that, when executed by processor(s) 220, cause device 200 to perform the techniques described herein. To do so, in some implementations, access control process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, access control process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that the access control process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further embodiments, access control process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, embeddings, etc.), based on an existing body of training data. Example generative approaches can include, but are not limited to, generative adversarial networks (GANs), large language models (LLMs), other transformer models, and the like.

As noted above, users in modern enterprises often create new content in the form of files such as spreadsheets, word processing documents, media files, and the like. These files are also often shared across users via document management systems, shared network folders, cloud storage locations, etc. For instance, one user may check in a version of a file to a shared repository, another may later open it to edit its contents, and then check it back into the repository. In other cases, a user may make copies of the file and share them internally and/or externally (e.g., via email, etc.).

Implementing access control to the various files in the network of an enterprise is frequently required by laws, regulations, best practices, company policies, and the like. For instance, files that include sensitive or confidential information such as sales figures, customer lists, or payroll information, may require security protections to prevent unauthorized access.

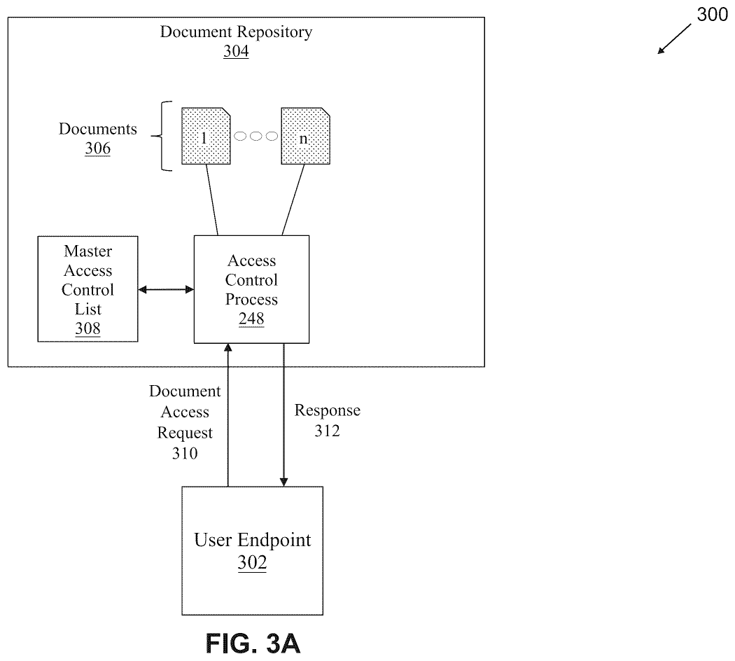

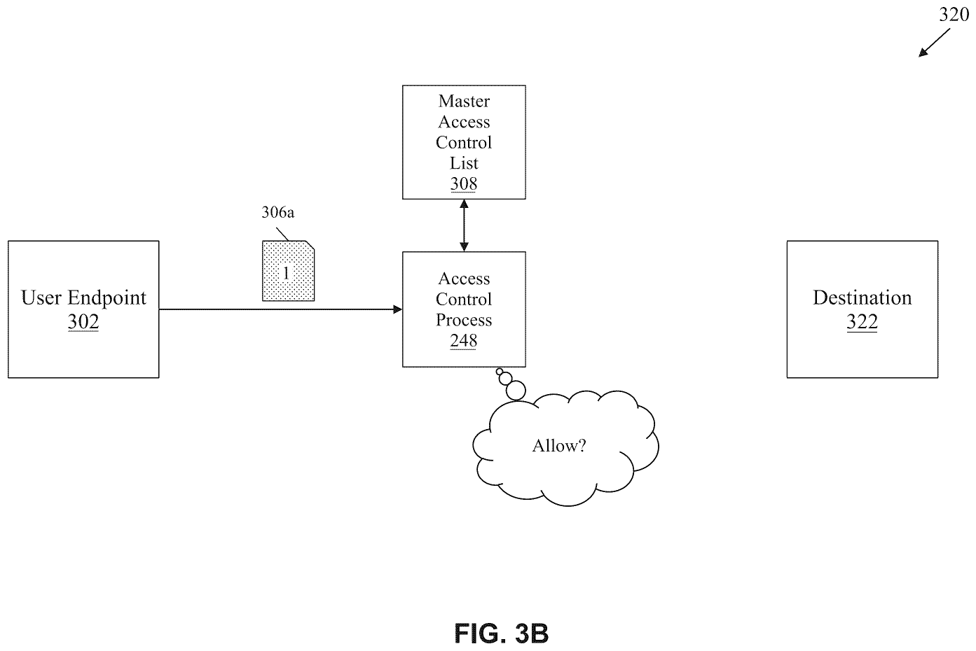

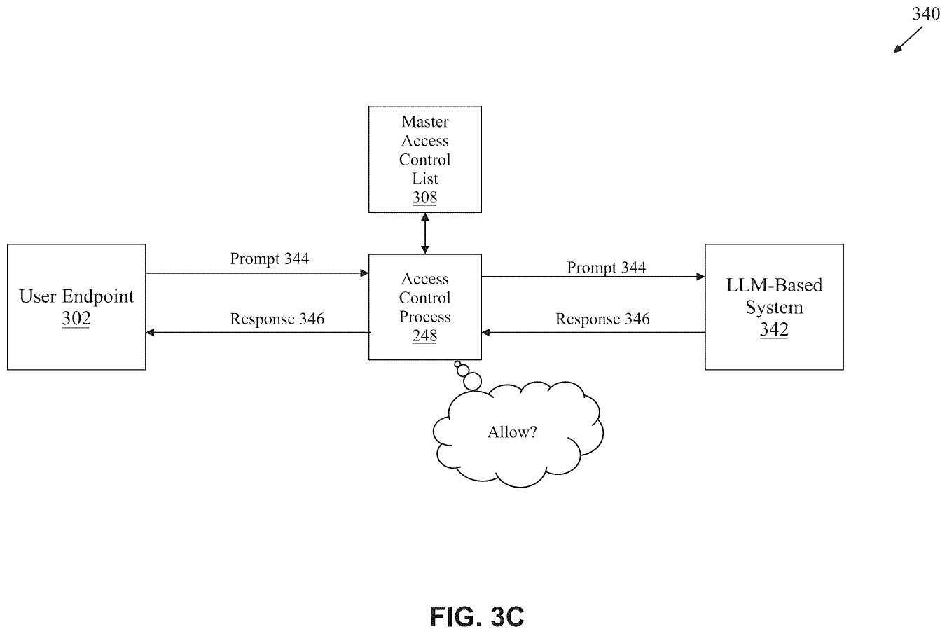

In various implementations, FIGS. 3A-3C illustrate examples of enforcing access controls to documents. More specifically, FIG. 3A illustrates an example 300 of access control process 248 preventing a user endpoint 302 preventing access to a particular document stored in a document repository 304. For instance, document repository 304 may take the form of a document management system, a file hosting service (e.g., Dropbox, Google Drive, etc.), a collaboration service (e.g., SharePoint, Slack, Webex, etc.), or any other system that allows multiple users to access documents/files via a computer network. Document repository 304 may also be internal and/or external to an enterprise network. In addition, document repository 304 may either store copies of documents 306 directly (e.g., documents 1-n) or links to their storage locations, which can be returned to a requesting user for retrieval.

To control access to documents 306, access control process 248 may serve to filter access requests for particular documents among documents 306 according to an master access control list 308. For instance, master access control list 308 may limit access to a particular document among documents 306 based on the identify of the requesting user, their role within the enterprise, their location, or other such factors.

By way of example, consider the case in which user endpoint 302 sends a document access request 310 on behalf of its user for a particular document among documents 306. If master access control list 308 indicates that the user is restricted from accessing that document, access control process 248 may prevent access to the requested document. In turn, access control process 248 may return a response 312 indicative of the document access request 310 being denied due to a lack of permissions. Conversely, if master access control list 308 allows the user to access the requested document, response 312 may instead include the document, which may take the form of the original file stored by document repository 304 or a copy thereof.

FIG. 3B illustrates another example 320 of an implementation of access control process 248. Here, again assume that there is a document 306a that has an associated entry in master access control list 308 that restricts access to it to a particular set of users. Unlike the case in FIG. 3A involving a document repository 304, example 320 illustrates another potential use case for access control process 248. As shown, access control process 248 may be executed by an intermediary device between user endpoint 302 and a destination 322 to which user endpoint 302 is attempting to send document 306a.

In this instance, user endpoint 302 may store a copy of document 306a and attempt to send document 306a to a destination 322, which may be associated with another user, service, etc. For instance, assume that user endpoint 302 is attempting to send document 306a to destination 322 via email, as an upload to a cloud service, or the like. In such a case, access control process 248 may assess the communication and determine whether or not to allow document 306a to be shared, based on master access control list 308.

FIG. 3C illustrates a further example 340 way in which access control process 248 may be implemented. Here, access control process 248 may act as an intermediary between user endpoint 302 (or any other endpoint) and an LLM-based system 342. For instance, LLM-based system 342 may take the form of a chatbot, voice assistant, or a system that takes multimodal data as input and is powered by an LLM or other suitable artificial intelligence/machine learning model.

During normal operations, user endpoint 302 may issue a prompt 344 to LLM-based system 342, which generates and returns a response 346 to endpoint 302. In various implementations, access control process 248 may treat prompt 344 and/or response 346 as their own documents for purposes of access control. For instance, if prompt 344 matches any prompts in master access control list 308 having an associated access control list (e.g., “What are our latest sales figures?” or some variation thereof), access control process 248 may determine whether to block or permit prompt 344 from being passed to LLM-based system 342. Similarly, if response 346 matches any entries in master access control list 308, access control process 248 may permit or reject it from being passed to user endpoint 302, based on the access control list for that entry.

Of course, examples 300, 320, and 340 are exemplary only and access control process 248 may be implemented as part of any other system that allows a document to be shared via a computer network. For purposes of the teachings herein, a document may take the form of a file or set of files, text, one or more images or videos, sounds, sensor readings, or a combination thereof. In addition, in example 340, prompt 344 is not limited to prompts issued by a user, but could also take the form of prompts sent by an application or other automated source. For instance, prompt 344 could alternatively be at least partially constructed by a retrieval augmented generation (RAG) mechanism associated with LLM-based system 342.

As noted, ideally, access control would be set on any given file to permit only relevant users to access it. However, accurately setting access controls can make documents hard to share and is often done incorrectly by non-technical personnel, leading to data loss. Current systems that seek to set access controls automatically can also exhibit poor performance because a single user may create documents targeted towards different audiences, depending on the content of the document.

### Access Control Labeling via LLM Semantic Understanding

The techniques introduced herein allow for the generation of an access control list for a new document created in a network. In some aspects, the techniques herein leverage a language model, such as an LLM, to derive semantic understanding of the idea(s) present in the document. In turn, the techniques may match the idea(s) to those present in existing documents and apply the access control list of the closest match(es) to the new document. Doing so allows the system to automatically apply access control security to new documents, without requiring a user to manually specify the access control list for the new document.

Illustratively, the techniques described herein may be performed by hardware, software, and/or firmware, such as in accordance with the access control process 248, which may include computer executable instructions executed by the processor (e.g., processor(s) 220) (or independent processor of interfaces (e.g., network interfaces 210)) to perform functions relating to the techniques described herein.

Specifically, according to one or more implementations of the disclosure as described in detail below, a device extracts, using an embedding model, one or more ideas from a particular document. The device determines a measure of similarity between the one or more ideas from the particular document and those of each of a body of existing documents, to identify a set of one or more similar documents. The device generates an access control list for the particular document, based on one or more access control lists associated with the set of one or more similar documents. The device restricts access to the particular document according to the access control list for the particular document.

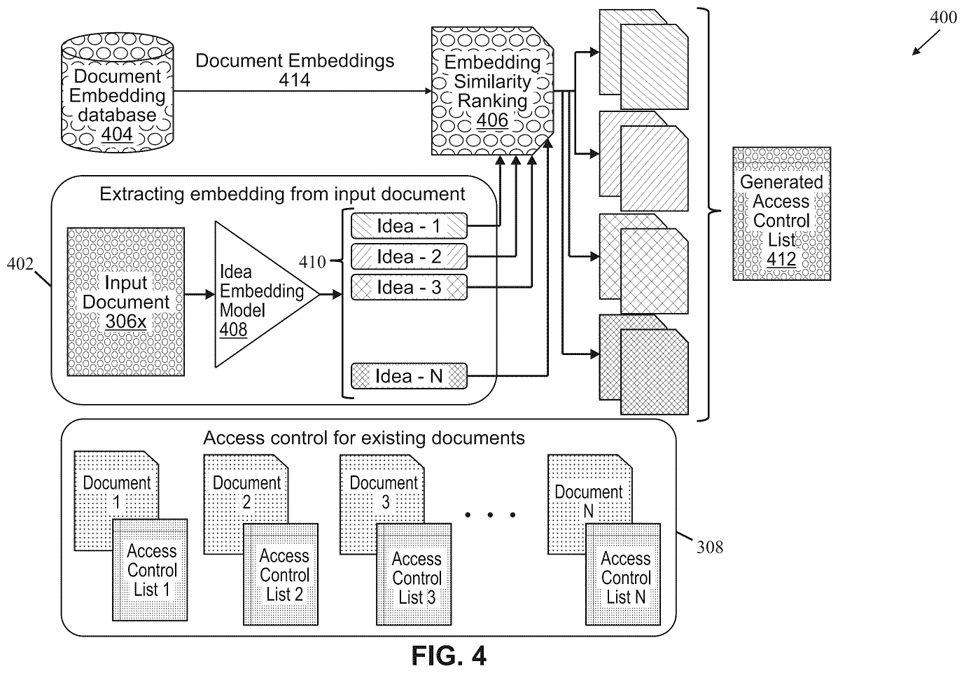

Operationally, FIG. 4 illustrates an example architecture 400 for access control labeling via Large Language Model (LLM) semantic understanding. As shown, access control process 248 may include any or all of the following components: an embedding extraction module 402, a document embedding database 404, and an embedding similarity ranking module 406. As would be appreciated, the functionalities of these components may be combined or omitted. In addition, these components may be executed in a device or in a distributed manner, in which case the combination of executing devices can be viewed as their own singular device for purposes of executing access control process 248.

As shown, assume that access control process 248 has access to the pre-existing master access control list 308 for documents 306 (e.g., documents 1-n). Here, each of documents 306 may have an associated access control list, which may specify the entities (e.g., users, applications, systems, locations, etc.) that are allowed to access that document and/or the entities that are to be prevented from accessing it. Now, consider the case in which access control process 248 encounters a new input document 306x that does not currently have an associated access control list in master access control list 308. In such a case, access control process 248 may then assess document 306x using extraction module 402.

In various implementations, extraction module 402 may include an idea embedding model 408 that is configured to extract the set 410 of one or more ideas (e.g., ideas 1-n) present in document 306x. To do so, idea embedding model 408 may take the form of any suitable embedding model (e.g., a machine learning-based model), such as a dedicated embedding model, an LLM, or the like.

The output of idea embedding model 408 will be set 410 of the one or more ideas in document 306x. Such a set may take the form of embeddings, which are vector representations of the language found within document 306x that denote their semantic meanings. For instance, assume that document 306x is a PowerPoint presentation intended for presentation to the board of directors of an enterprise and includes confidential sales figures for the preceding sales quarter. In such a case, one of the embeddings may correspond to the idea of confidential sales figures.

Once extraction module 402 has extracted set 410 of the idea(s) present in document 306x, embedding similarity ranking module 406 may determine the similarity of set 410 to that of the embeddings of documents 306. To do so, access control process 248 may maintain document embedding database 404 that stores embeddings of documents 306. For instance, idea embedding model 408 may assess each of documents 306 to populate 404.

Based on the semantic similarity between document 306x and the documents in documents 306 (e.g., by comparing the distances between their embeddings), embedding similarity ranking module 406 may generate a ranking of one or more documents from documents 306 that are closest in terms of their constituent ideas to that of document 306x.

In various implementations, embedding similarity ranking module 406 may then take the i-number of semantically closest documents from documents 306 to that of document 306x and assess their corresponding access control lists from master access control list 308. From this, embedding similarity ranking module 406 may then generate an access control list 412 for document 306x for inclusion in master access control list 308. In some implementations, embedding similarity ranking module 406 may do so by taking the intersection of access control lists for the top i-number of documents, to determine the entities that should be permitted or denied access to document 306x in access control list 412.

In one implementation, in cases where there are no similar documents (e.g., the similarity between embeddings is below a defined threshold), embedding similarity ranking module 406 can also use descriptions of the users'roles in the company for comparison, to generate access control list 412. Alternatively, embedding similarity ranking module 406 may instead notify a user via a user interface, to manually specify access control list 412 for document 306x.

After generating access control list 412, access control process 248 may include it in master access control list 308 for use to allow or prevent access to document 306x by the entities specified by access control list 412. As would be appreciated, such entities may take the form of individual users, groups of users, user roles, geographic or network locations, applications, etc.

Said different, when presented with a new, unseen document, access control process 248 may create idea-level embeddings. These embeddings could be formed by combining document-level and topic-level information. In turn, access control process 248 may use these idea-level embeddings to compare the closeness of multiple documents. A set of the most similar documents is then retrieved from the existing set. The new access list is then derived from the intersection of the access lists of each retrieved document.

In further implementations, access control process 248 may also operate on the output of an LLM itself (e.g., a different LLM than that of idea embedding model 408 or the same model), treating the output akin to a document above. The idea here is that one of the issues with LLMs is that they potentially leak confidential training data. The system may have a user submit a prompt, then take the output from the LLM and generate the same kind of embedding described above for access control.

Using the embeddings, they system could compare them with a database of sensitive documents or topics and decide if the user had the required permissions to access this information. For example, assume that an LLM is trained on sales data, so that salespeople or their managers could ask questions about it. Then, an engineer later asks something that results in sales related data coming out of the LLM. Extraction module 402 may then feed this output into idea embedding model 408 and idea embedding model 408 may compare the resulting embeddings with those of the existing company documents, including the sales data spreadsheets. In such a case, access would be denied because engineers should not have access to sales data.

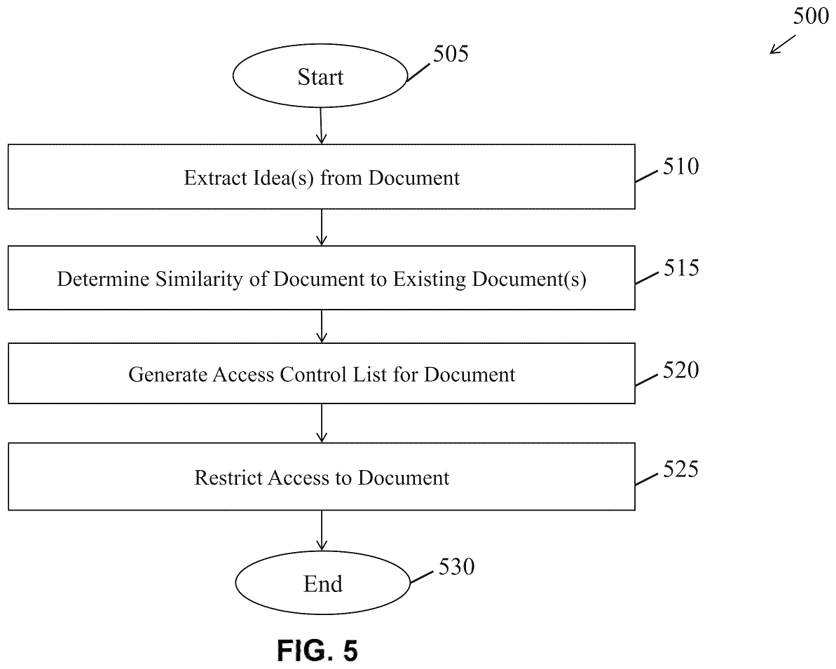

FIG. 5 illustrates an example simplified procedure (e.g., a method) for performing access control labeling via LLM semantic understanding, in accordance with one or more implementations described herein. For example, a non-generic, specifically configured device (e.g., device 200) may perform procedure 500 by executing stored instructions (e.g., access control process 248). The procedure 500 may start at step 505, and continues to step 510 where, as described in greater detail above, the device may extract, using an embedding model, one or more ideas from a particular document. In some implementations, the device extracts the one or more ideas from the particular document by using the embedding model to generate vector embeddings that represent the one or more ideas present in the particular document. In one implementation, the particular document comprises an input prompt for a large language model (LLM). In another implementation, the particular document comprises an answer generated by an LLM. In a further case, the particular document is a file. In one implementation, the embedding model comprises an LLM. In a further implementation, the particular document is an email.

At step 515, a detailed above, the device may determine a measure of similarity between the one or more ideas from the particular document and those of each of a body of existing documents, to identify a set of one or more similar documents. For instance, the device may determine the semantic distance between the ideas (or embeddings representing the ideas) as the measure of similarity.

At step 520, the device may generate an access control list for the particular document, based on one or more access control lists associated with the set of one or more similar documents, as described in greater detail above. In various implementations, the device generates the access control list for the particular document by aggregating the one or more access control lists associated with the set of one or more similar documents. In some implementations, the access control list restricts access to the particular document to at least one of: a set of one or more authorized users, a set of one or more authorized groups, or a set of one or more authorized locations.

At step 525, as detailed above, the device may restrict access to the particular document according to the access control list for the particular document. In some instances, the device may do so by preventing, by the device, the particular document from being transmitted across a computer network.

Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for performing access control labeling via LLM semantic understanding, it is to be understood that various other adaptations and modifications may be made within the spirit and scope of the implementations herein. Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
extracting, by a device and using an embedding model, one or more ideas from a particular document;
determining, by the device, a measure of similarity between the one or more ideas from the particular document and those of each of a body of existing documents, to identify a set of one or more similar documents;
generating, by the device, an access control list for the particular document, based on one or more access control lists associated with the set of one or more similar documents; and
restricting, by the device, access to the particular document according to the access control list for the particular document.

2. The method as in claim 1, wherein restricting access to the particular document comprises:
preventing, by the device, the particular document from being transmitted across a computer network.

3. The method as in claim 1, wherein the device extracts the one or more ideas from the particular document by using the embedding model to generate vector embeddings that represent the one or more ideas present in the particular document.

4. The method as in claim 1, wherein the device generates the access control list for the particular document by aggregating the one or more access control lists associated with the set of one or more similar documents.

5. The method as in claim 1, wherein the particular document comprises an input prompt for a large language model (LLM).

6. The method as in claim 1, wherein the particular document comprises an answer generated by a large language model (LLM).

7. The method as in claim 1, wherein the access control list restricts access to the particular document to at least one of: a set of one or more authorized users, a set of one or more authorized groups, or a set of one or more authorized locations.

8. The method as in claim 1, wherein the particular document is a file.

9. The method as in claim 1, wherein the embedding model comprises a large language model (LLM).

10. The method as in claim 1, wherein the particular document is an email.

11. An apparatus, comprising:
one or more network interfaces;
a processor coupled to the one or more network interfaces and configured to execute one or more processes; and
a memory configured to store a process that is executable by the processor, the process when executed configured to:
extract, using an embedding model, one or more ideas from a particular document;
determine a measure of similarity between the one or more ideas from the particular document and those of each of a body of existing documents, to identify a set of one or more similar documents;
generate an access control list for the particular document, based on one or more access control lists associated with the set of one or more similar documents; and
restrict access to the particular document according to the access control list for the particular document.

12. The apparatus as in claim 11, wherein the apparatus restricts access to the particular document by:
prevent the particular document from being transmitted across a computer network.

13. The apparatus as in claim 11, wherein the apparatus extracts the one or more ideas from the particular document by using the embedding model to generate vector embeddings that represent the one or more ideas present in the particular document.

14. The apparatus as in claim 11, wherein the apparatus generates the access control list for the particular document by aggregating the one or more access control lists associated with the set of one or more similar documents.

15. The apparatus as in claim 11, wherein the particular document comprises an input prompt for a large language model (LLM).

16. The apparatus as in claim 11, wherein the particular document comprises an answer generated by a large language model (LLM).

17. The apparatus as in claim 11, wherein the access control list restricts access to the particular document to at least one of: a set of one or more authorized users, a set of one or more authorized groups, or a set of one or more authorized locations.

18. The apparatus as in claim 11, wherein the particular document is a file.

19. The apparatus as in claim 11, wherein the embedding model comprises a large language model (LLM).

20. A tangible, non-transitory, computer-readable medium storing program instructions that cause a device to execute a process comprising:
extracting, by the device and using an embedding model, one or more ideas from a particular document;
determining, by the device, a measure of similarity between the one or more ideas from the particular document and those of each of a body of existing documents, to identify a set of one or more similar documents;
generating, by the device, an access control list for the particular document, based on one or more access control lists associated with the set of one or more similar documents; and
restricting, by the device, access to the particular document according to the access control list for the particular document.
